(19) United States
(12) Patent Application Publication
(10) Pub. No.: US 2011/0285585 A1
(43) Pub. Date: Nov. 24, 2011

(54) Position Location Using Opportunistic Analog and Digital Radio-Frequency Signals

(76) Inventor: Marcos Antonio Bergamo, Wellesley, MA (US)

(21) Appl. No.: 13/106,098

(22) Filed: May 12, 2011

Related U.S. Application Data
(60) Provisional application No. 61/334,615, filed on May 14, 2010.

(51) Int. Cl. G01S 19/48; G01S 5/02

(52) U.S. Cl. 342/357.31; 342/463

(57) ABSTRACT

A method and apparatus for determining the synchronization and the position of terminals comprising of methods and apparatus for receiving a plurality of signals from opportunistic transmitters such as analog or digital radio/television broadcast and cellular tower signals; down-converting, sampling and processing such signals without requiring demodulation or detection of specific channel or timing features; re-transmitting the signals to another terminal or processing center; correlating the received and re-transmitted signals while generating estimates for differential ranging relative to each opportunistic transmitter and differential frequency and time synchronization offset for each pair of terminals; determining the position or coordinates of the at least two terminals using corresponding differential range measurements while using differential ranging measurements from three or more of such opportunistic transmitters.

This non-provisional application is a conversion of provisional application No. 61/334,615 filed May 14, 2010

### BACKGROUND OF THE INVENTION

1. Prior Art

There have long been methods of two-dimensional latitude/longitude position determination systems using radio signals. In wide usage have been terrestrial systems such as Loran C and Omega, and a satellite-based system known as Transit. Another satellite-based system enjoying increased popularity is the Global Positioning System (GPS). The GPS system is based on a constellation of 24 on-orbit satellites in sub-synchronous 12-hour orbits. Each satellite carries a precision clock and transmits a pseudo-noise signal, which can be precisely tracked to determine pseudorange. By tracking 4 or more satellites, one can determine precise position in three dimensions in real time, worldwide. More details are provided in B. W. Parkinson and J. J. Spilker, Jr., Global Positioning System-Theory and Applications, Volumes I and II, AIAA, Washington D.C. 1996.

GPS has revolutionized the technology of navigation and position location. However in some situations, GPS is less effective. Because the GPS signals are transmitted at relatively low power levels (less than 100 watts) and over great distances, the received signal strength is relatively weak (on the order of −160 dBW as received by an omni-directional antenna). Thus the signal is marginally useful or not useful at all in the presence of blockage or inside a building. A code-tracking GPS receiver measures the raw difference between the receiver's biased clock and the transmitted time of the start of the satellite code phase (which is part of the satellite message). This quantity, called raw pseudorange, equals the true range from the receiver to the satellite plus an unknown offset between the receiver clock and the satellite clock and includes time-of-arrival (TOA) measurement errors, satellite time errors and additional time delays caused by the ionosphere, troposphere, as well as noise, multipath and intrinsic receiver errors. Satellite clock errors are differences in the true signal transmission time and the transmission time implied by the GPS navigation message. In the presence of Selective Availability (SA), clock errors corresponding to 30×30 meter area uncertainty are no unusual. Typically, a GPS receiver generates a corrected pseudorange by correcting the raw pseudo-range measurement for estimates of some of the raw errors. As known, GPS localization performance can be greatly improved using ground references and differential techniques, such as ones used in Differential GPS (DGPS) systems or with ground-based transmitters configured to emit GPS like signals (i.e., GPS pseudolites).

The main purpose of all DGPS systems is to estimate the receiver's stand-alone ranging error so that a more accurate pseudorange can be used to estimate position. Effective application of the differential corrections requires high-quality GPS reference receivers at known, surveyed localization. In order for a DGPS correction to be effective, both the receiver and the reference must be using the same satellite ephemeris and the time of the reference station correction must be passed to the receiver as part of the correction messages. In addition, the reference station must take great care to not introduce additional errors by including correction for effects that are not measured by the receiver and any pseudorange correction must be agreed upon by both receiver and reference and they must be applied in the same way. In certain environments including inside building, urban settings with high-rise buildings and tactical military theaters these are hard requirements to meet. First, access to GPS may not be available for long periods-of-time, making pseudorange measurements and associate clock offset estimates difficult. The clocks (i.e., absolute time) among the tactical radios will drift driven by the long-term frequency stability of the local oscillator (1 ppm is not unusual). Second, using DGPS-like pseudolites for enhancing and/or replacing GPS has benefits, but comes associated with a number of technical, management and coordination issues. One relevant technical issue is the pseudolite signal power level and the associated near-far effect that a user receiver may experience, depending upon the signal strength variation as distance changes. Relevant management and coordination issues for the tactical environment include deployment requirements, signal data rate, signal integrity monitoring, and user antenna localization and sensitivity.

A more practical alternative for localization and navigation in such environments uses opportunistic references and has the potential of achieving GPS-like performance when GPS is denied. A system has been proposed using conventional analog National Television System Committee (NTSC) television signals to determine position. This proposal is found in a U.S. patent entitled “LOCATION DETERMINATION SYSTEM AND METHOD USING TELEVISION BROADCAST SIGNALS,” U.S. Pat. No. 5,510,801, issued Apr. 23, 1996. However, the techniques disclosed suffer from several major shortcomings. The techniques cannot use signals that are severely attenuated, such that conventional analog TV receivers cannot extract synchronization timing from the horizontal synch or chrominance burst. The techniques cannot accommodate the frequency offset and the short-term instability of the analog transmitter clocks, which would cause severe position errors because the user must sequentially sample one channel after another. The techniques cannot resolve cycle ambiguities in the chrominance carrier, especially in the presence of multipath. Further, the techniques do not enable one to use signals that have variable characteristics that do not effect the performance of an analog television receiver, but considerably affect the performance of a navigation system (for example, the variable shape and duration of the blanking pulse, the horizontal synch pulse, and the chrominance burst).

Another system has been proposed using techniques for position location using analog broadcast television (TV) Signals. This other proposal is found in a U.S. patent entitled “POSITION LOCALIZATION USING BROADCAST ANALOG TELEVISION SIGNALS,” U.S. Pat. No. 6,961,020, B2, issued Nov. 1, 2005. The techniques disclosed mitigate some of the shortcomings of the previous technique including the abilities to tracking signals that are below the noise floor, working inside buildings and extracting timing information in a manner far more precise than a typical television receiver, and accommodating typical variable characteristics of the analog TV signal through the use of monitoring stations. However, the techniques disclosed also suffer from several major shortcomings. The techniques require the analog broadcast television signal to have a periodic component such as a chrominance burst or horizontal synchronization and blanking pulses; terminal with apparatus to receive such a periodic components; monitor stations with accurate clocks to track the frequency and time-offsets of in-range television transmitters; means for terminals or processing centers to communicate parameters and generate reference signals based on selected periodic signal components; and means for the processing nodes performing the pseudorange measurements to communicate and adjust the pseudo-ranges based on television signals time and frequency offsets measured by the monitor stations, and clock and frequency offsets between terminals and monitor stations.

Other systems have been proposed using techniques for position location using digital television (DTV) broadcast signals and pseudo DTV broadcast signals. These other proposals are found in the following U.S. patents: U.S. patent entitled “POSITION LOCATION USING DIGITAL VIDEO BROADCAST TELEVISION SIGNALS,” U.S. Pat. No. 7,126,536B2, issued on Oct. 24, 2006 and U.S. Pat. No. US 2007/0008220 A1, issued on Jan. 11, 2007; and U.S. patent entitled “POSITION LOCATION AND DATA TRANSMISSION USING PSEUDO DIGITAL TELEVISION TRANSMITTERS,” U.S. Pat. No. 6,963,306B2, issued Nov. 8, 2005. The techniques disclosed in these patents also suffer from several major shortcomings. As with the previous technique for analog television broadcast signals, the techniques for digital television broadcast signals also require the terminals to receive a KNOWN component of the television broadcast signal such as wireless orthogonal frequency-division multiplexing (OFDM) signal comprising a scattered pilot signal component of the DTV signal; and monitor stations to receive and track the clock, time offset, and frequency offset of DTV transmitters relative to a master time reference and a reference clock selected from one of the monitor stations or derived from a GPS signal.

2. Field of the Invention

The present invention relates generally to navigation systems using external references, and particularly to the determination of Position, motion and synchronization of terminals or sensor using opportunistic analog or digital broadcast transmitters including AM and FM broadcast radio and television signals.

### SUMMARY OF THE INVENTION

In summary, in accordance with the purposes of the invention, as embodied and broadly described herein, the invention comprises a method for synchronizing and determining the position of terminals that derive synchronization and localization capabilities from awareness of opportunistic references, such as FM, TV and cell base stations. The resulting methods and techniques, in addition to DO NOT requiring the referential signals to be digital or have any periodic, pilot, or synchronization signal component, they provide significantly greater capability for terminals and wireless users in general to determine their position than is presently possible in GPS-denied environments while achieving significant positioning accuracy when GPS is not available, and, in contrast with conventional Differential GPS (DGPS) systems, does not require any cooperation from the referential transmitters.

### OBJECTS OF THE INVENTION

An object of this invention is directed to methods that enable accurate localization and synchronization of terminals when GPS is not used or is not available using techniques that, contrary to prior art, DOES NOT require monitor stations to track the time reference, clock and frequency of opportunistic referential signals such as television broadcast signals, and IS NOT limited to using analog signals that a have a periodic component, or digital signals that include a component signal used for synchronization such as the scattered pilot signal of the DTV signal.

Another object of the invention is to use any apparatus transmitting an electromagnetic signal from which its position (i.e., coordinates) can be determined over time as a referential transmitter, independently of being fixed with respect to ground such as radio, television and cellular telephone base station transmitters installed on buildings, mountains or towers, or mobile transmitters such as when the referential transmitters are mounted in aircraft, unmanned aerial vehicles (UAV) and satellites.

Another object of the invention is to differentiate it from prior art methods, the invention does not require receiving any specific component of the referential signal, thereby the methods that comprise the invention do not require having any specific knowledge of the nature, format, parameters, air interface or specific component signal of the referential signals. Accordingly, the referential transmitter can be ANY radio broadcast station or public safety radio base station independently of the modulation, whether amplitude modulation (AM), frequency modulation (FM) or digital audio modulation (DAB or DAB+); any television broadcast, whether analog television broadcast or digital video broadcast (DVB); any wireless cell base station independently of the air interface, whether GSM (global system mobile), AMPS (advanced mobile phone service), TDMA (time-division multiple access), CDMA (code division multiple access), or the like; and any WiMAX Broadband Wireless Access (BWA) base station independently of the specific air-interface specification used including IEEE 802.16, or the like.

The methods and techniques object of this invention create an environment in which, when GPS is not available and/or access to GPS has been denied, pair-wise terminal synchronization is achieved by receiving a common but otherwise arbitrary opportunistic referential signal OR SIGNALS originated at a certain location, and terminal position determination is achieved by receiving opportunistic referential signals from such referential transmitters placed at three or more distinct locations. The method comprises the steps of using an apparatus for tuning to and receiving selected spectrum segments including the whole spectrum of an opportunistic referential signal, sampling and storing such received signals; processing such sampled signals, decimating such sampled-and-processed signals; transmitting such received sampled-and-processed signals to other terminals or to a processing center; performing correlations to determine time-offsets including fractional-sample clock offset between local referential clocks at each terminal, frequency-offset including frequency differences between local oscillators at each terminal and differential time-of-arrival (DTOA) including determining corresponding differential ranges and uncertainties while correcting for corresponding differential clock and frequency offsets; performing such correlations for at least one common opportunistic referential signal; perform calculations to determine the 2D or 3D coordinates of a terminal relative to the coordinates of three or more opportunistic transmitters or terminals or the location of an opportunistic referential transmitter relative to other opportunistic referential transmitters or terminals; perform tracking to updated the time-and-frequency synchronization and range-and-location or coordinates of a given terminal or opportunistic referential transmitter.

The methods and techniques object of this invention select the length of the correlation blocks and perform the correlation measurements at or near the correlation peaks, such that the invention can track signals received with low power including signals which are received below the noise floor, and for which a conventional television signal receiver or a prior art localization receiver receiving a component signal of an analog or a digital television broadcast signal would be unable to acquire timing information. Accordingly, the techniques that comprise the invention extract timing information in a manner far more robust and precise than a typical television receiver and prior art localization receivers.

In the preferred implementation mode described herein, the referential transmitters are selected from opportunistic electromagnetic transmitters with different angular or non-aligned 3D (i.e., xyz) coordinates.

In some embodiments, transmitters from two or more different broadcast services or base stations may be mounted on a same tower, thus having identical 2D or xy-coordinates and typically different heights or z-coordinates. The invention can use such different signals from such distinct transmitters located at the same xy location or tower, independently of the frequency, format, air interface and nature of each broadcast signal whether analog or digital, as a single referential opportunistic signal for the purposes of terminal localization and synchronization.

The revelation that differentiates this invention from prior art, the methods that comprise the invention use intra-band differential or interferometry techniques to accommodate and mitigate all the variable characteristics of an opportunistic referential signal, including variations in the carrier frequency, such that these variations do not affect the precision of obtained synchronization and position location for a terminal, and for which a prior art localization receiver using analog or digital television broadcast signals would require monitor stations to track both the time and the frequency offsets of such referential broadcast signals. The correlation methods that determine the relative time synchronization or frequency offset between two terminals compare the signals received at each terminal from at least two sub-bands of at least one referential signal. The correlation methods that determine the 2D-coordinates of a terminal compare the signals received by at least two terminals from at least two sub-bands of at least three referential signals from electromagnetic transmitters including broadcast transmitters Which are not collinear with the at least two terminals. The correlation methods that determine the 3D-coordinates of a terminal compare the signals received by at least two terminals from at least two sub-bands of at least six referential signals from electromagnetic transmitters including broadcast transmitters which are not coplanar with the at least three terminals and at least one subset of three of such referential transmitters are not collinear with the at least two terminals.

Specifically, the invention applies correlation techniques to signals from distinct and possibly overlapping sub-band received from each referential signal including different referential signals from a same 2D-location to determine the differential propagation time delay or the differential distance or range between two terminals receiving from a common referential signal or referential signals from a common 2D-location. The referential signal reception at each terminal comprising the methods of:
Selecting at least two radio-frequency (RF) sub-bands of a referential RF signal such that each RF Sub-Band has an arbitrary but otherwise fixed, known or mutually agreed upon nominal center frequency in which the corresponding center frequencies are determined at each terminal relative to the frequency of a local oscillator at each user terminal;
Generating clock signals for the sampling operations such that such sampling signals are synthesized from same local oscillator used to generating the mixing frequencies, each frequency mixing signal tuned preferably at the center frequency of each sub-band of each referential signal;
Mixing the signals received from each RF Sub-Band with each frequency mixing signal synthesized from such a common local oscillator generating at least two intermediate-frequency or IF Signals in which each of such IF Signals corresponds to one of such RF Sub-Band signals;
Generating a Baseband Product Signal by re-mixing two of such IF Sub-Band Signals such that the Baseband Product Signal includes the product of two Sub-Band Baseband Signals in which each Sub-Band Baseband Signal corresponds to each RF Sub-Band of a referential broadcast signal;
Performing such mixing and related filtering operations in the analog and/or digital domains;
Generating a Received Discrete-Time Baseband Signal while using a sampling clock corresponding to at least the Nyquist frequency of one of the sub-band signals such as the sub-band signal with the largest bandwidth.

In some embodiments, the Received Discrete-Time Baseband Signal is digitized using an apparatus such as an analog-to-digital converter (A/D), time-stamped, and stored for an opportunistic transmission to another terminal or correlation center. Transmission is performed using a protocol with parameters or overhead fields that enable different terminals to identify which blocks contain data from each referential signal and corresponding times in which such blocks were received at each terminal.

In some embodiments, the information about reception times or referential sources can be omitted. In these cases, block correspondence is determined at each terminal using cross-correlation properties among such received blocks.

In some embodiments, the invention can tune and select whole spectrum “chunks” that include the candidate RF Sub-bands, then digitize the whole spectrum “chunk,” and then perform digitally all operations required to select specific RF sub-bands including filtering and mixing operations including performing such operations digitally using FPGAs or ASICs or software.

In some embodiments, the knowledge of the center frequency and bandwidth of an electromagnetic signal used as a referential signal could be used to facilitate the implementation of terminal's receiver apparatus. The preferred implementation mode described herein assumes that terminals know or are informed of the geographical position and nominal spectrum characteristics of potential referential transmitters and corresponding nominal spectrum characteristics including nominal center frequency and nominal bandwidth.

### BRIEF DESCRIPTION OF THE DRAWINGS

FIG. 1 shows an exemplary localization system including exemplary Opportunistic Referential Transmitters (or ORTs), User Terminals and communication networks.

FIG. 2 shows an exemplary ORT spectrum and relevant User Terminal range, frequencies and synchronization parameters.

FIG. 3 shows an exemplary ORT spectrum with exemplary non-overlapping narrowband sub-channels.

FIG. 4A shows an exemplary ORT spectrum with exemplary overlapping sub-channels with wider bandwidth.

FIG. 4B shows two ORTs with same xy-coordinates and distinct spectrum and sub-channels being used as a common ORT for the location.

FIG. 5A shows the block diagram of an exemplary User Terminal digital receiver architecture using agile filtering.

FIG. 5B shows the block diagram of an alternative User Terminal digital receiver architecture using synthesized mixing signals.

FIG. 5C shows the block diagram of yet another alternative architecture for the User Terminal's digital receiver.

FIG. 6 shows an exemplary way for a receiver to capture an ORT signal and generate the data blocks exchanged between User Terminals.

FIG. 7 shows exemplary propagation delays, sub-band frequencies, frequency- and time-offsets including relative synchronization uncertainties and timing errors.

FIG. 8 shows the method for calculating the phase offset such that is suitable for differential range measurements.

### DETAILED DESCRIPTION OF THE PREFERRED EMBODIMENT

### General Method

The Intra-Band Interferometry (IBI) method, as described herein, enables two nodes to measure their relative synchronization and simultaneously measure their relative range to an Opportunistic Referential Transmitter (ORT) by simply capturing RF emissions from such an ORT and then exchanging and correlating the captured data. The method is general, works with arbitrary radio-frequency (RF) signals, and uses a processing method that does not require making any assumption about the contents or nature of such emissions or about the real-timeliness of the exchange of the collected data between User Terminals through the network. Combining IBI measurements from at least three non-aligned ORTs made by at least two User Terminals enables determining the position (i.e., coordinates) of the User Terminals relative to the ORTs (or vice-versa).

The IBI method object of this invention and described herein has the following capabilities:
Allows ANY analog or digital AM, FM, TV or cell base station signal, including pseudolites and drop-along relays, to be used as an opportunistic reference for localization and synchronization WITHOUT requiring the corresponding signals to be tracked (at RF or baseband), detected, or demodulated;
Enables time synchronization between different User Terminals WITHOUT requiring line-of-sight or unusual time and/or frequency synchronization between such User Terminals;
Enables estimating differential range accurately REGARDLESS of the frequency stability of such ORTs and WITHOUT requiring unusual long-term time and/or frequency synchronization among the participating nodes (e.g., User Terminals with 1 ppm local oscillators may suffice), while using ANY means not necessarily in real-time for reliably exchanging captured data among User Terminals.

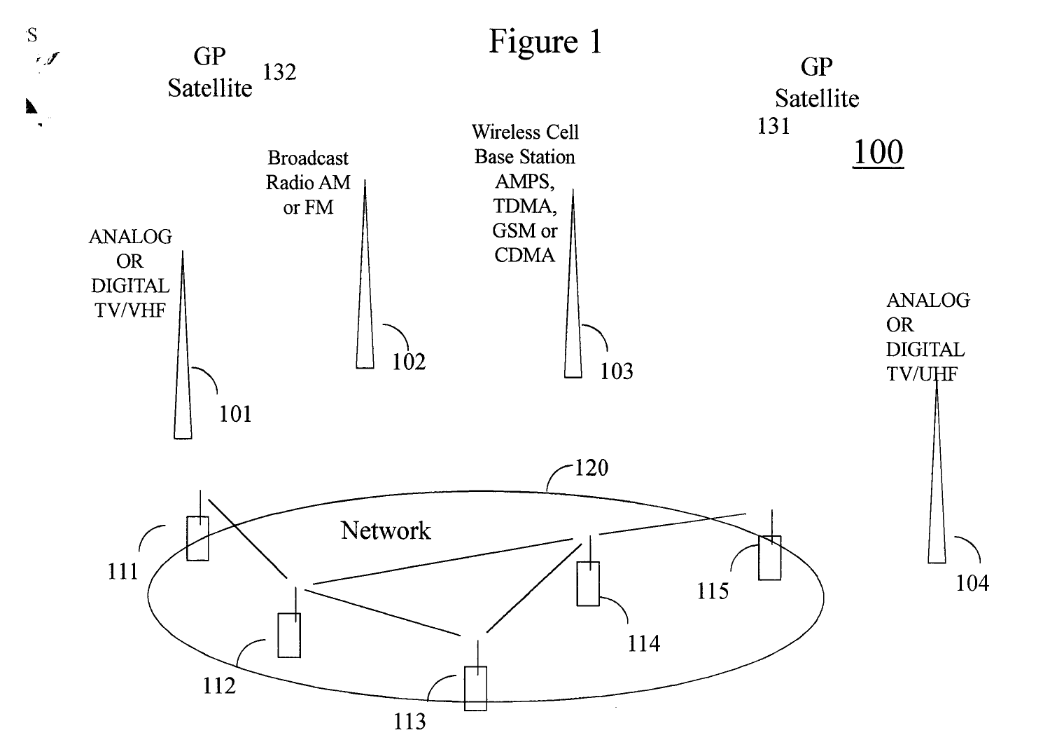

FIG. 1 is used to illustrate various aspects of the invention but the invention is not limited to this implementation. For example, the phrase user terminal is meant to refer to any object capable of implementing the location determination and synchronization operations described herein. Examples of user terminals include PDAs, mobile phones, cars and other vehicles, and any object which could include a chip or software implementing position location and/or synchronization functions. It is not intended to be limited to objects which are terminals or which are operated by users. The location and synchronization functions described herein require correlating data received by at least two of such terminals. This correlation can be performed at one of the terminals, at both terminals or somewhere else. The word network is meant to refer to any means for transferring collected data between two points including but not limited to the telephone network, a cellular network, the Internet, and the physical delivery of an apparatus used to store or record such data.

Various methods can be used to select which Opportunistic Referential Transmitters (ORT) and channels each terminal should use for position location and synchronization. In one embodiment, a server (not shown) or User Terminal performing the function of a server, tells another User Terminal which ORT and channels to use, the position location of such an ORT and, for each ORT, the identity of participating User Terminals that may include all or a subset of the User Terminals in range or with a line-of-sight (LOS) view of such an ORT. In another embodiment, the User Terminals autonomously search for candidate ORTs and corresponding sub-band channels, and dynamically discover the identity of such cooperating User Terminals.

Specifically, FIG. 1 illustrates an exemplary ground-based configuration 100 used for the position location and synchronization methods object of this invention. It includes User Terminals 111-115 capable of tuning to and receiving from at least one of the ORTs 101-104 and then exchanging captured data through a network 120. The invention makes no assumptions about the nature of the communication between User Terminals over the network except that they can, and opportunistically will, exchange selected parts or all the collected data from at least one of such ORTs. Using the methods object of the invention described herein the User terminals will mutually synchronize in time and in frequency and determine their location (i.e., coordinates) relative to the locations of the ORTs without requiring communicating with or receiving signals from other localization system such as GPS satellites 131-132. GPS Geo-location, although not required, can be incorporated in the system whenever they are or become available.

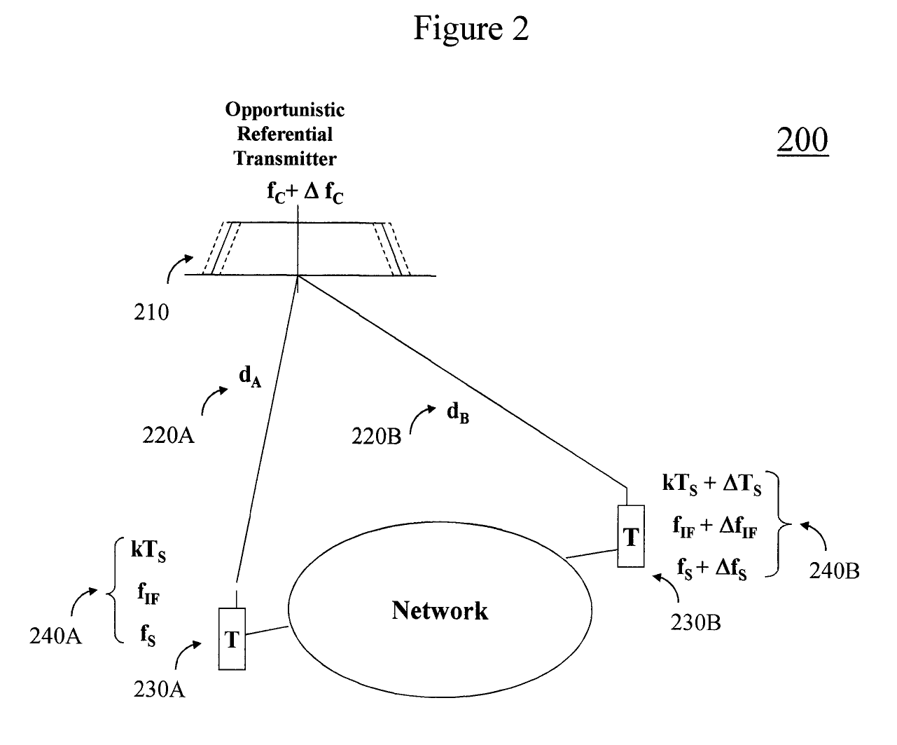

FIG. 2 illustrates a network configuration 200 used for measuring the differential range and the differential synchronization both in time and in frequency between two exemplary User Terminals 230A and 230B by receiving and exchanging data received from a common ORT 210 such as an analog of digital TV station 101 and 103 AM or FM radio broadcast station 102 or cell base station 103. The method object of this invention does not require nor make any assumption about the frequency stability of the ORT signal except that the participating User Terminals have agreed to use such an ORT as a common source for collecting related data and then exchange and use such collected data for the synchronization and localization operations described herein. Such an agreement can be programmed or hard wired in the terminals, established a priori through configuration, or achieved dynamically using a predefined including but not limited to prior art protocol.

In the preferred implementation, all relevant frequency or time related signals of the exemplary User Terminals 230A and 230B, including sampling clock and down-converter frequencies, are synthesized from a common local oscillator at each User Terminal. Local oscillators from different User Terminals are not synchronized in frequency and their resulting sampling clocks are not aligned in absolute time. In the figure, Δf_{C} represents the instantaneous error in absolute frequency for the selected ORT signal including center frequency or sub-channel; Δf_{S} represents the instantaneous error in frequency for the selected sampling frequency f_{S}, and ΔT represents the error in time between and exemplary User Terminal 230B relative to User Terminal 230A. The key parameters for mutual time and mutual frequency synchronization are the absolute time error ΔT and Δf_{S} respectively. The method object of this invention estimates the value of f_{S} including error differential Δf_{S} and use such an estimate to generate and synchronize all frequencies of User Terminal 230B relative to User Terminal 230A. The key parameter for determining the coordinates of a User Terminal is the phase differential corresponding to the differential propagation delay (d_{A}−d_{B}). In the preferred implementation, the estimates for these three parameters ΔT, Δf_{S} and (d_{A}−d_{B}) are performed using a single pair of corresponding sampled spectrum data blocks, each block received by one of the participating User Terminals. In the preferred implementation, using the methods and techniques described herein:
The differential propagation delay (d_{A}−d_{B}) manifests itself as a phase shift and is measured using a phase differential technique described herein that, contrary to prior art techniques does not have cycle ambiguity;
The absolute time error ΔT manifests itself as a frequency shift and is measured using conventional frequency measurement methods, including prior-art frequency estimation techniques;
The sampling frequency error offset Δf_{S} also manifests itself as a frequency shift and is also measured using conventional frequency measurement methods, including prior-art frequency estimation techniques.
In one embodiment, data collection from the selected ORT signal 210 is performed by tuning the User Terminal to at least two agreed a priori (or negotiated) RF sub-channels. In another embodiment, the User Terminal can collect data including the entire spectrum of the ORT signal and then select the sub-channels using digital filtering or software.

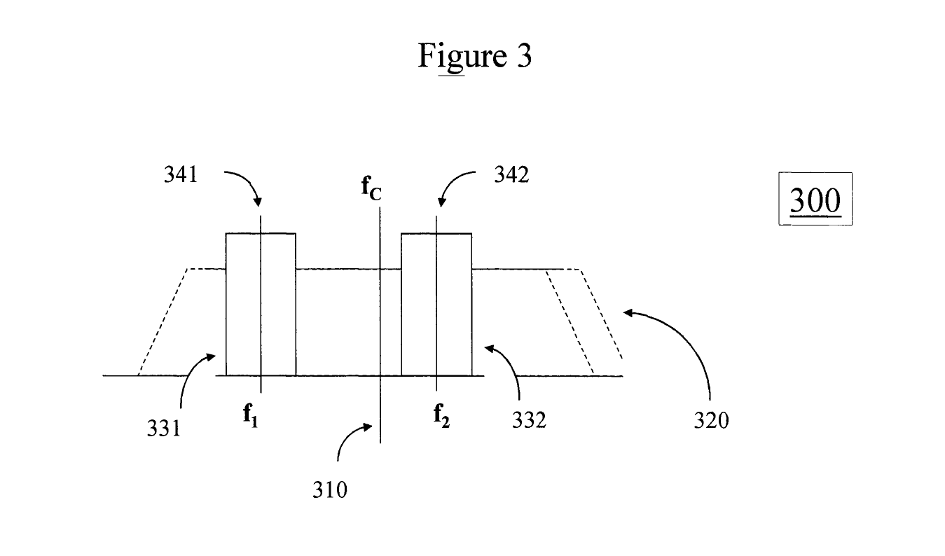

FIG. 3 illustrates exemplary ORT RF spectrum 320 with exemplary center frequency f_{C} (310), included RF sub-channels 331 and 332, each sub-channel with exemplary nominal center frequencies f₁ (341) and f₂ (342) respectively. In general, the bandwidth and the filter parameters that characterize the exemplary RF sub-channels 331 and 332 can be different. In the preferred implementation, both the bandwidth and the filter parameters that characterize such exemplary sub-channels are the same (i.e., identical), except for the corresponding center frequencies and possibly noise characteristics. In the preferred implementation, the signals corresponding to each of the RF sub-band signals have each the characteristics of a narrowband signal. Also, in the preferred implementation, both the center frequency and the bandwidth of the sub-channels are selected such that, for each sub-channel, a significant portion of the sub-channel spectrum including the spectrum of the entire sub-channel is contained within the frequency range of the bandwidth of the ORT signal 320. The center frequency and bandwidth of the participating sub-channels can be selected as illustrated in FIG. 3 to maximize the separation of the center frequencies 341 and 342 of the participating sub-channels 331 and 332.

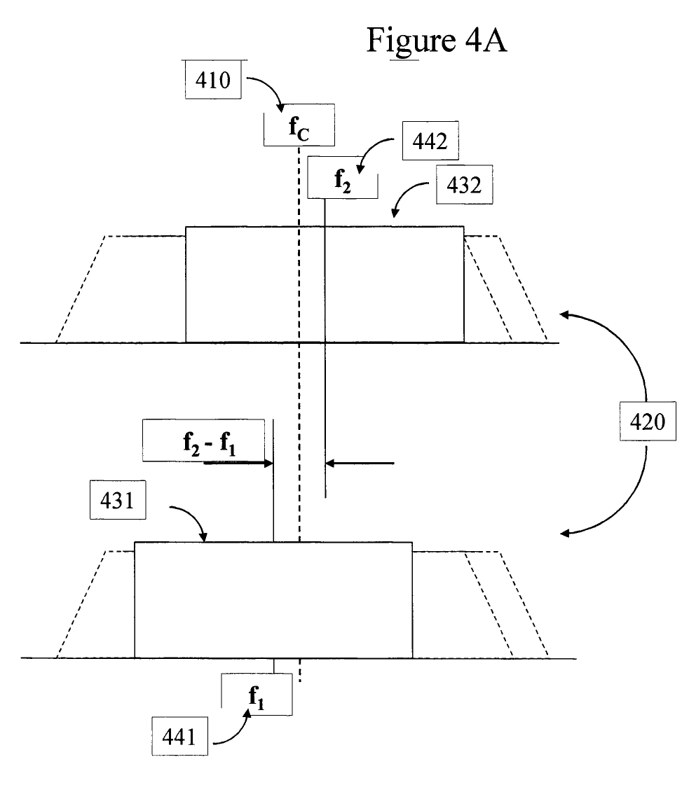

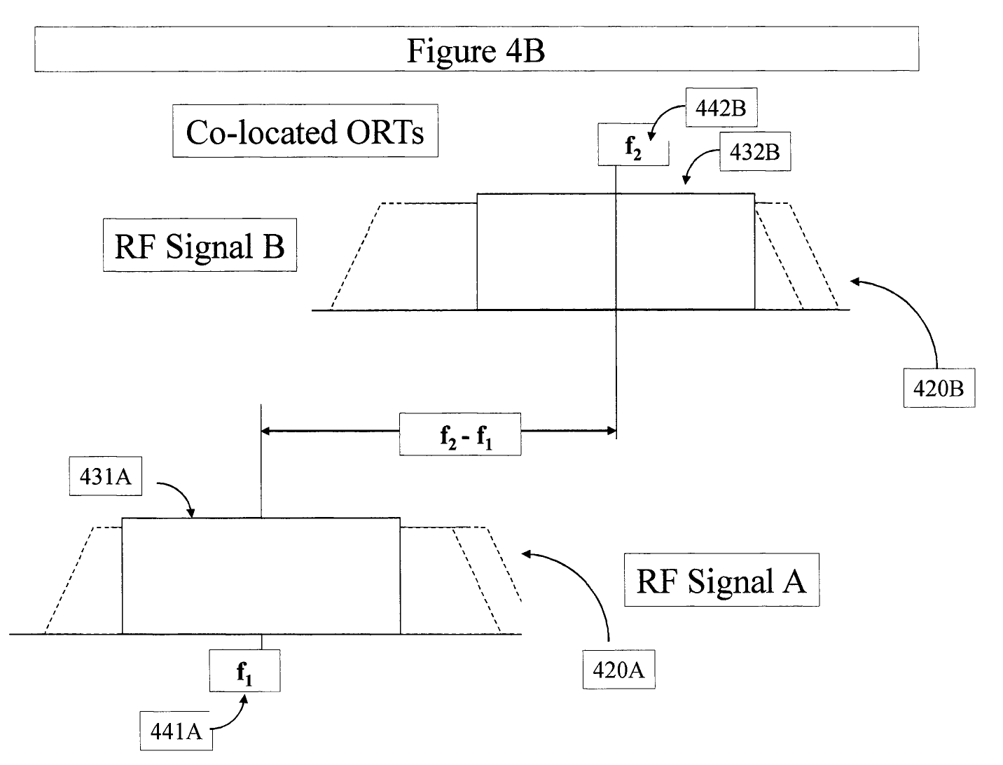

FIG. 4A illustrates the spectrum 420 of the exemplary ORT with wider-bandwidth, overlapping sub-channels 431 and 432. The invention can flexibly select the center frequencies 441 and 442 and the bandwidth of the sub-channels regardless of overlapping. At will become apparent, the invention may use different selections of center frequencies and bandwidth to generate multiple synchronization and range measurements while re-using spectrum data collected and/or exchanged between terminals. Also important for the implementation aspects of the invention, the sub-channels 431 and 432 do not have to be received simultaneously at any given terminal. According to the methods described herein, it will become apparent that channel selection by different terminals have to be coordinate, with time overlaps, such the data these terminals collect from a given ORT and/or sub channel are correlated.

FIG. 4B illustrates the spectrum 420A and 420B of two different but collocated ORTs (e.g., in the same pole or tower), with possibly the same 2D or xy-coordinates and different heights of z-coordinates. As mentioned above, the nature of the RF signals 420A and 420B can be different (TV station and cell base station), and the sub-channels 441A and 441B can be selected from such different ORT signals including selecting the whole spectrum of each ORT signal 420A and/or 420B. As it will become apparent, the synchronization and ranging methods included in the invention are such that they can flexibly use sub-channels from distinct but collocated ORTs as a single ORT for that location. In addition, reception from these sources is not required to be performed simultaneously at any specific terminal. In this case, depending on the bands and/or center frequencies of the participating signals, the differential frequency f₂ can be relatively large (e.g., 100's MHz to 10's GHz) and as it will be described herein, enable range measurements with fine resolution inversely proportional to such frequency differential. Also, the methods included in the invention can flexibly select signals and sub-channels as illustrated in FIGS. 3, 4A and 4B to reduce the uncertainty and/or ambiguity of the synchronization and range measurements related to a selected ORT or ORT location.

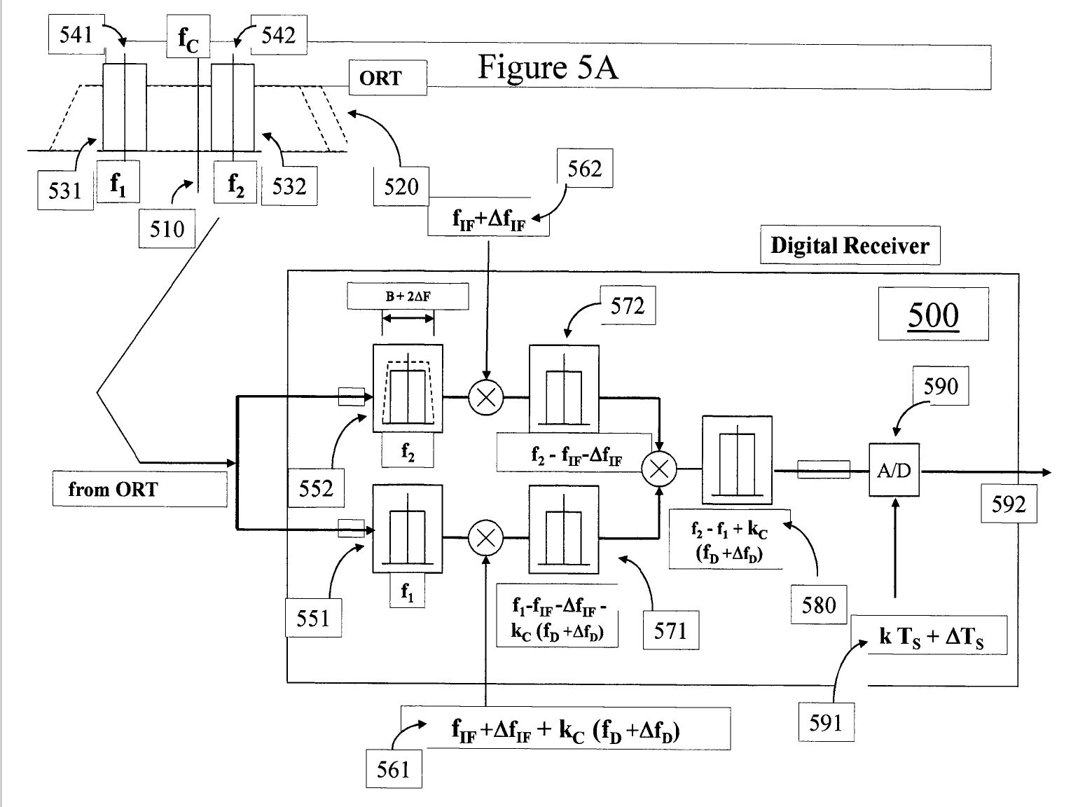

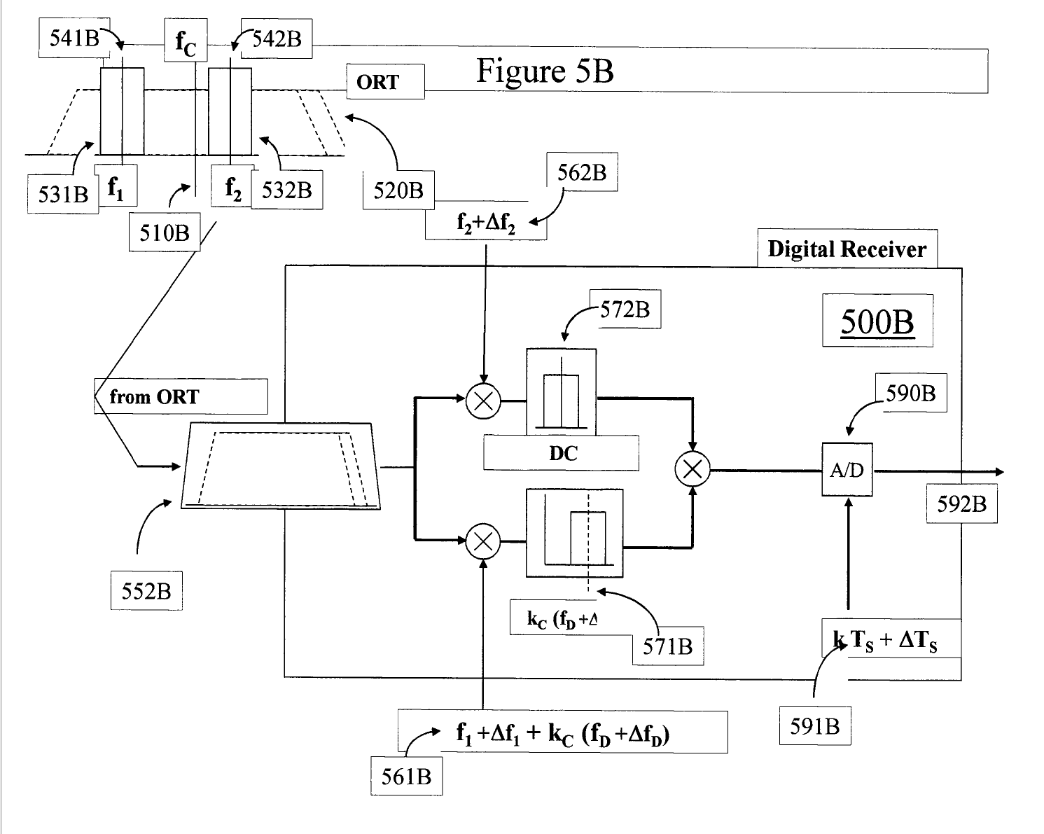

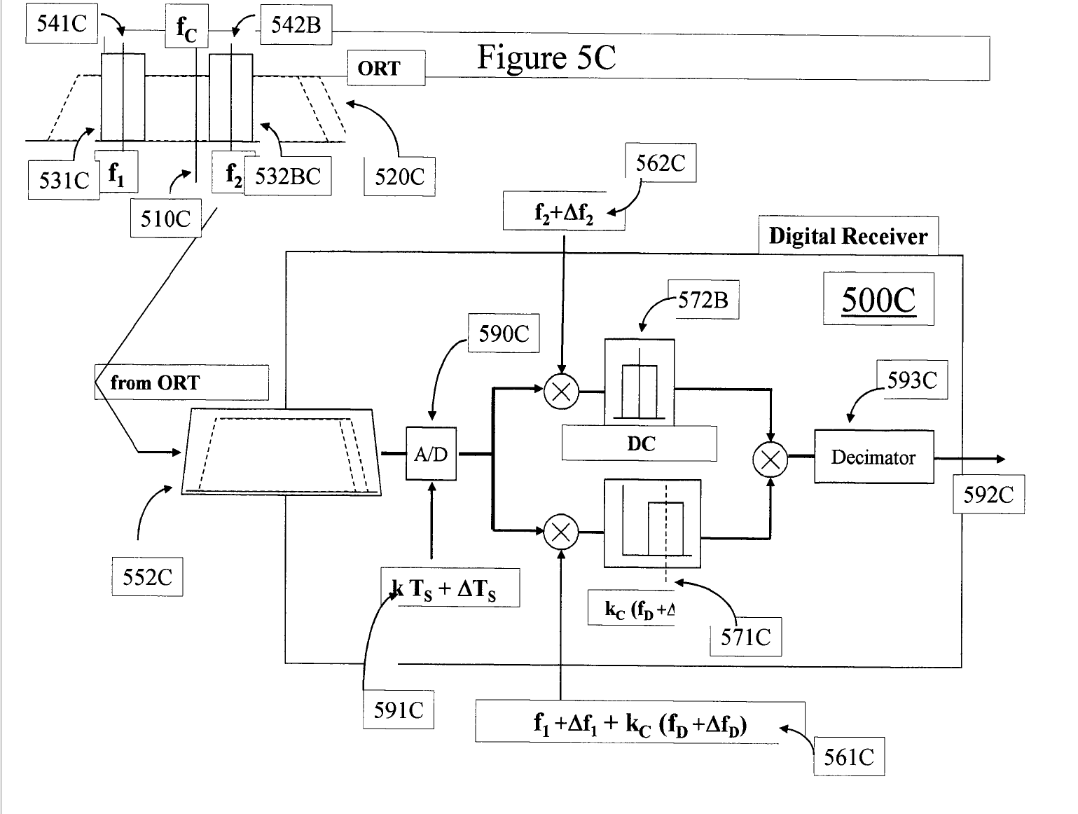

FIG. 5A illustrates exemplary operations for a digital receiver 500 used in the invention to receive and down-convert the signal received from the ORT using exemplary analog mixing techniques. Other signal mixing techniques including but not limited to direct down-conversion using polyphase filtering, full digital processing including receiving and sampling the RF signals directly at RF and/or any combination thereof can also be used. At each User Terminal (e.g., 230A and 230B of FIG. 2), signal down-conversion from RF to baseband is performed in a way such as to enable and facilitate the isolation of estimates for the following parameters: differential range (d_{A}−d_{B}) from the exemplary User Terminals to a selected ORT; and differential time ΔT and differential sampling frequency (Δf_{S}) between such exemplary terminals. In the preferred implementation, such an isolation is achieved by using conventional mixing for one of the sub-channels such as the exemplary sub-channel 532, and varying-frequency mixing including chirp mixing including stepped-frequency mixing for the other exemplary sub-channel 531. Tuning to and selection of the participating sub-channels can be performed as illustrates by the exemplary front-end filters 551 and 552. Alternatively, and equivalently, such a sub-channel selection can be done digitally using spectrum data collected for a segment of the ORT spectrum that includes the participating sub-channels, including the whole spectrum of the ORT. The bandwidth of such filters is selected such as to accommodate the bandwidth B of the selected sub-channels 531 and 532 while including the worst-case RF frequency uncertainty that may exist between the exemplary participating terminals. The mixing frequencies for each sub-channel are selected such as to generate a down-converted signal centered at a common intermediary frequency f_{IF}. In the circuit performing the standard or conventional mixing operation, the mixing frequency 562 is kept constant over the whole duration of the data collection for the sub-channel 532. In the circuit performing the varying-frequency mixing, the varying mixing frequency 561 is made to change over the time used to collect the spectrum data for sub-channel 531. In the preferred implementation for the varying-frequency mixing, data is collected in blocks and the mixing frequency is kept constant within each block while changing from block to block by an exemplary frequency-step f_{D}. In general, the method object of this invention can accommodate the use of any function for controlling the way in which the frequency changes within a block (i.e., continuous-frequency chirping) or from block to block (i.e., stepped frequency chirping). The bandwidth of the second pair of filters 571 and 572 is selected such as to accommodate the maximum frequency span to the varying-frequency signal 561 used in the mixing operations or alternatively the center frequencies can change as required while the bandwidth B is maintained constant. As illustrated in FIG. 5, the resulting signals at the output of the filters 571 and 572 are re-mixed and passed through an exemplary filter 580. In the preferred implementation with stepped frequency mixing the center frequency of the exemplary filter 580 changes in steps of f_{D} Hertz, while the changes in the frequency of the varying-frequency component occur in lock-step with the block boundaries. In an alternative implementation, both the center frequency and the bandwidth of the filter 580 are kept constant. In the preferred implementation the signal at the output of filter 580 is converted to digital using an analog to digital converter (ADC) 590 while using a sampling signal with frequency f_{S}+Δf_{S} in which Δf_{S} represents the instantaneous frequency difference between the exemplary User Terminal 230B relative to User Terminal 230A of FIG. 2. Actual sampling is performed at sampling times 591 (kT_{S}+ΔT_{S}) in which k is the sampling index, T_{S}=1/f_{S} is the nominal sampling period and ΔT_{S} is the time offset of the exemplary User Terminal 230B with respect to the exemplary User Terminal 230A. Finally, the signal 592 at the output of the ADC 590 which contains information about the differential range (d_{A}−d_{B}) and of the differential parameters included in 240B becomes available to be transmitted to other terminals. The actual data exchanged between terminals can be transmitted as is or decimated as required to meet requirements such as the bandwidth to the actual RF sub-channels or system constraints such as the instantaneous throughput of the channels between participating terminals.

FIG. 5B illustrates an alternative embodiment in which the whole spectrum 552B of the ORT is captured and the RF sub-channel selection is implemented using the filters 571B and 572B.

FIG. 5C illustrates yet another alternative embodiment in which the whole ORT spectrum 552C is converted to digital using the A/D converter 590C while using a sampling frequency 591C and the RF sub-band selection, down-conversion and final mixing operations are performed digitally including being performed in software. In certain embodiments the resulting digitized signal may be decimated at the decimator 593C before the signal 592C is made available for transmission to other participating terminals.

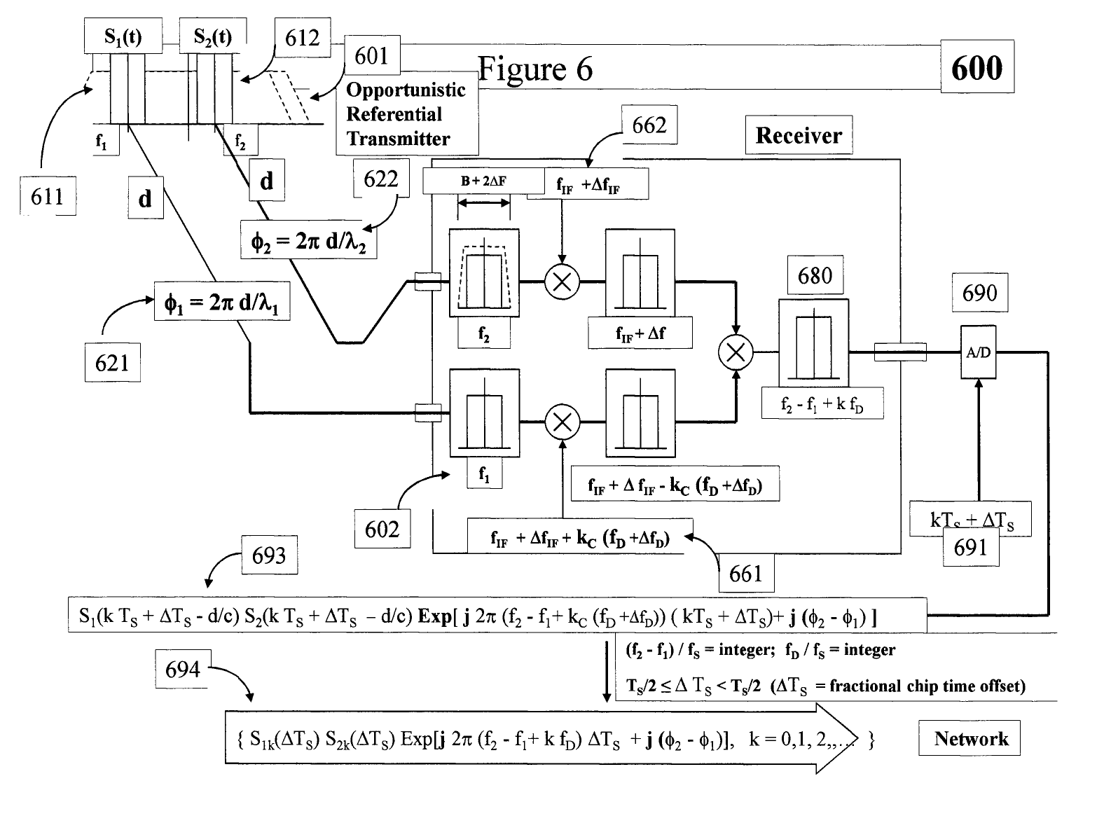

FIG. 6 illustrates the operation of the Receiver including a Digital Receiver of an exemplary User Terminal 230B while receiving and capturing spectrum data from two sub-channels of an exemplary ORT signal 601. The standard mixing frequency 662, the varying mixing frequency 661 and sampling frequency 691 are all synthesized from a common local oscillator using exemplary integer factors. In this case, the collected signal samples by the User Terminal 230B located at a distance de from the ORT can be accurately expressed as

$$\{ {S}_{{1}_{k}} ( Δ T + Δ {τ}_{B} ) {S}_{{2}_{k}} ( Δ T + {Δτ}_{B} ) Exp [ I 2 π ( ( \frac{{d}_{B}}{{λ}_{2}} - \frac{{d}_{B}}{{λ}_{1}} ) + ( {f}_{2} - {f}_{1} ) Δ T ) ) ] Exp [ I 2 π {kf}_{D} Δ T ] Exp [ I 2 π {k}^{2} ( \frac{{f}_{D}}{{f}_{s}} ) {( \frac{Δ {f}_{S}}{{f}_{S}} )}^{2} ] , k = 1 , 2 , 3 , … \} \qquad Equation 1$$

where:
S₁ₖ(.) and S₂ₖ(.) represent the complex-valued sampled signal at the k^{th} sample-time interval kT_{S}≦Δτ_{B}<(k+1)T_{S} is the residual fractional-sample propagation delay between the ORT and the User Terminal 230B.

φ₁=2πd/λ₁ and φ₂=2πd/λ₂ represent the phase rotation due to the propagation delay over a distance d for the signals corresponding to the sub-channels centered respectively at f₁ and f₂.

k=1, 2, 3 . . . are indices for different data blocks, each corresponding to a different step kf_{D} for the mixing frequency used in the lower arm of the figure.

With prior art approaches using conventional RF-to-IF-to-baseband conversion, and without using a varying-frequency mixing technique described herein, it is not possible to differentiate between the phase shift caused by the propagation delay (i.e., Δφ=2πd(1/λ1−1/λ2) and the phase shift 2π(f₂−f₁)ΔT introduced by the simply fact that the clock between different User Terminals are not aligned in absolute time. This is why in the receiver 650, the mixing operation is performed as illustrated such that the corresponding baseband signals include a signal component with a varying frequency component corresponding to the term Exp[I2πkf_{D}ΔT] in equation (1). In the invention, the use of a mixing component with varying frequency 661 including a mixing frequency that is constant within a block but varies from block to block (i.e., stepped frequency) enables a User Terminal (e.g., 230B) to capture information about the other terminal's (e.g., User terminal 230A) notion of absolute time in the form a varying-frequency signal component in which the frequency increases proportionally to the time misalignment ΔT.

As it will become apparent in the description herein, the differential time ΔT only manifests itself (i.e., can be detected) when one compares signals from a common ORT as received by different User Terminals such as 230A and 230B in FIG. 2. For this, samples corresponding to the signal represented by equation (1) are arranged in blocks, time stamped and exchanged between participating User Terminals or, alternatively, they are sent a common processing center (aka Correlation Center) using the communication services provided by the underlying data network including Internet services, cellular services or specialized ad hoc wireless services. Also, at will become apparent, this “communication” can be opportunistic and the methods object of this invention make no assumption about the synchronization or real-time nature of such communication. In general, both the block size in samples and the rate in which these blocks are transmitted may vary as a function of the availability and instantaneous throughput of the underlying data network.

At the Correlation Center or alternatively at a User Terminal performing corresponding correlation operations, blocks containing spectrum samples collected by different User Terminals from different ORTs are grouped according to common ORTs and, for each ORT, sorted according to common block time of arrival (BTOA) including time-stamps. Correlations are performed first with the objective of estimating the time-offset ΔT. In the preferred implementation, estimation of such a time offset is performed by first partitioning the blocks in sub-blocks, and then correlating the sub-blocks and collecting corresponding results at our around correlation peaks. The frequency in which these peaks (collected in a convenient form) vary over the length of the block provides a direct estimate of the actual time uncertainty ΔT. With this estimate, the invention performs corrections in the original block. The invention includes the configuration and/or adaptation capabilities in which the number of samples per block is a system parameter that can be different for different ORTs depending on received power levels.

Typically, for narrowband signals, Δf_{S}<<f_{S}ΔT and reasonable simplifications can be represented as:

$$\{ {s}_{{1}_{k}} ( Δ T + {Δτ}_{B} ) {S}_{{2}_{k}} ( Δ T + {Δτ}_{B} ) Exp [ I 2 π ( ( \frac{{d}_{B}}{{λ}_{2}} - \frac{d}{λ} ) ] , k = 1 , 2 , 3 , … \} \qquad Equation ( 2 )$$

This signal can then be correlated with the corresponding block received locally from the same ORT. At the correlation peak, the resulting signal can be expressed as

$${\sum }_{k} {S}_{{1}_{k}} ( Δ T + {Δτ}_{B} ) {S}_{{2}_{k}} ( Δ T + {Δτ}_{B} ) {S}_{{1}_{k}}^{*} ( {Δτ}_{A} ) {S}_{{2}_{k}}^{*} ( {Δτ}_{A} ) Exp [ I 2 π ( {d}_{B} - {d}_{A} ) ( \frac{1}{{λ}_{2}} - \frac{1}{{λ}_{1}} ) ] \qquad Equation ( 3 )$$

The above expression, focusing on the phase or argument of the resulting signal, simplifies to

$$\begin{matrix} Exp [ I 2 π ( {d}_{B} - {d}_{A} ) ( \frac{1}{{λ}_{2}} - \frac{1}{{λ}_{1}} ) + Θ ( Δ T , {Δτ}_{A} , {Δτ}_{B} ) ] & Equation ( 4 ) \\ Exp [ I 2 π ( \frac{{d}_{B} - {d}_{A}}{{λ}_{12}} ) + Θ ( Δ T , {Δτ}_{A} , {Δτ}_{B} ) ] \\ Where & Equation ( 5 ) \\ Θ ( Δ T , {Δτ}_{A} , {Δτ}_{B} ) = Arg [ {\sum }_{k} {S}_{{1}_{k}} ( Δ T + {Δτ}_{B} ) {S}_{{2}_{k}} ( Δ T + {Δτ}_{B} ) {S}_{{1}_{k}}^{*} ( {Δτ}_{A} ) {S}_{2}^{* A} ( {Δτ}_{A} ) ] & Equation ( 6 )\end{matrix}$$

Since the signals S₁(t) and S₂(t) are (or can be selected to be) narrowband, Θ(ΔT, ΔT_{A}, ΔT_{B})˜0. Since the signals from the ORT have typically a high SNR and/or the length of the collected signals S₁(t) and S₂(t) can be selected such as the resulting correlated signal has a high SNR, the Arg[.] of signal at the output of the correlator when observed at the correlation peak as per expression (4) provides a good estimate of the differential range d_{B}-d_{A}.

Indeed, at high SNR, the standard deviation σΘ for the argument of the amplitude component of the correlated signal is typically σΘ<1°. For a differential frequency f₂−f₁=300 KHz, with and equivalent λ₁₂=1000 meters, this corresponds to an error on the estimated differential distance of approximately 3 meters (i.e., ˜±10 nanoseconds).

In addition, since

$$\begin{matrix}( {d}_{B} - {d}_{A} ) ( \frac{1}{{λ}_{2}} - \frac{1}{{λ}_{1}} ) = \frac{{d}_{B} - {d}_{A}}{c} ( \frac{c}{{λ}_{2}} - \frac{c}{{λ}_{1}} ) \\ = \frac{{d}_{B} - {d}_{A}}{c} ( {f}_{2} - {f}_{1} ) \\ = \frac{{d}_{B} - {d}_{A}}{\frac{c}{{f}_{2} - {f}_{1}}} \\ = \frac{{d}_{B} - {d}_{A}}{{λ}_{12}}\end{matrix} \qquad Equation ( 7 )$$

the differential range (d_{B}−d_{A}) will be measured relative to the equivalent wavelength λ₁₂ given by

$${λ}_{12} = \frac{{λ}_{1} {λ}_{2}}{{λ}_{1} - {λ}_{2}} \qquad Equation ( 8 )$$

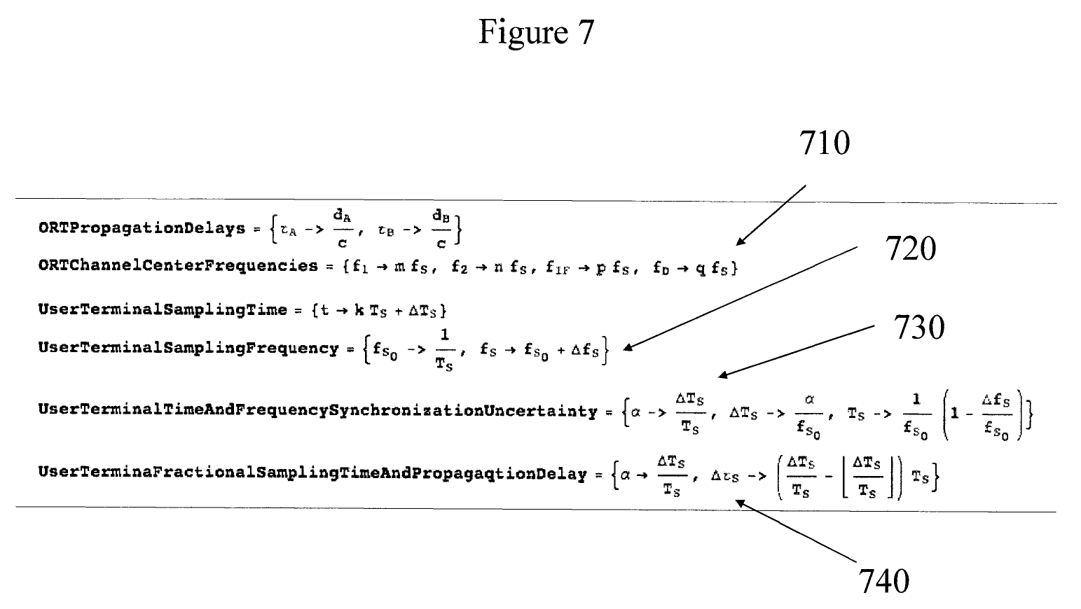

FIG. 7 shows exemplary propagation delays, sub-band frequencies, frequency- and time-offsets including relative synchronization uncertainties and timing errors. All mixing frequencies in a given terminal including sub-band frequencies f₁ and f₂, and step frequency f_{D} are phase-locked to the local sampling frequency f_{S}. In the preferred embodiment 710, these “mixing” frequencies are selected but not required to be an integer multiple (m, n and q respectively) of the sampling frequency f_{S}. In the preferred embodiment 720, they all User Terminal have same nominal Value f_{S0} and the sampling frequencies of different User Terminals are not mutually synchronized, having a differential sampling frequency Δf_{S}. In addition, the sampling times are not synchronized in absolute time and the corresponding fractional sampling time differential 730 also needs to be estimated as and then used to correct the measured delay differential including fractional sample time delay differential 740.

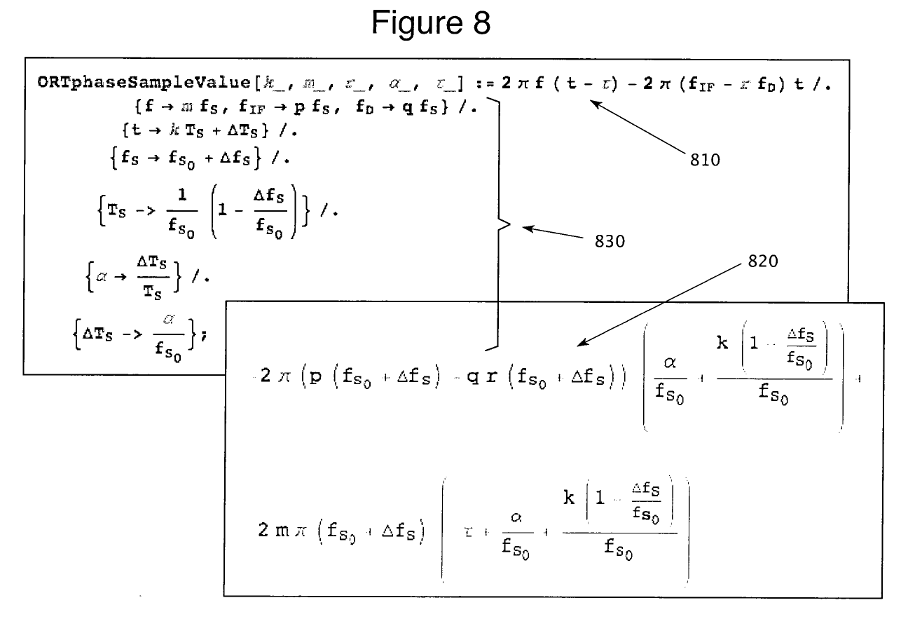

FIG. 8 shows the phase of the signal received from an exemplary ORT using two references for time and frequency: local to a node 810 and relative to another node 820 with all the time and frequency differentials included in 830. This phase is used in the following section to determine estimates for the differential propagation delays, differential sampling frequency and relative fractional sample time offset.

### DETAILED ESTIMATES METHOD

### 1. Signals

### 1.1 Parameters

The list below shows the various signal parameters used by the position determination method described herein
LU: Localization Unit (=RF attachment to a User Terminal radio)
ORT: Opportunistic RF Transmitter
τ: propagation delay
d: distance of a participating node to an ORT
f: generic frequency
f₁: center frequency of sub-channel 1
f₂: center frequency of sub-channel 2
f_{S0}: nominal sampling frequency
f_{S}: actual sampling frequency
Δf_{S}: sampling frequency offset (assumed constant for the duration of a block)
f_{D}: block-by-block chirp frequency quantum step
f_{IF}: nominal IF frequency
ΔT: actual block time offset between two nodes (assumed constant for the duration of a block)
ΔT_{S}: fractional sample time offset between two nodes (assumed constant for the duration of a block)

### 1.2 Relationship Among Parameters

$$\begin{matrix}{τ}_{A} -> \frac{{d}_{A}}{c} & {τ}_{B} -> \frac{{d}_{B}}{c} & \\ {f}_{1} -> {mf}_{S} & {f}_{2} -> {nf}_{S} & {f}_{IF} -> {pf}_{S} {f}_{D} -> {qf}_{S} \\ t -> {kT}_{S} + Δ {T}_{S} & & \\ {f}_{{S}_{0}} -> \frac{1}{{T}_{S}} & {f}_{S} -> {f}_{{S}_{0}} + Δ {f}_{S} & \\ α -> \frac{Δ {T}_{S}}{{T}_{S}} & Δ {T}_{S} -> \frac{α}{{f}_{{S}_{0}}} & {T}_{S} -> \frac{1 - \frac{Δ {f}_{S}}{{f}_{{S}_{0}}}}{{f}_{{S}_{0}}} \\ α -> \frac{Δ {T}_{S}}{{T}_{S}} & {Δτ}_{S} -> {T}_{S} ( - Floor [ \frac{Δ {T}_{S}}{{T}_{S}} ] + \frac{Δ {T}_{S}}{{T}_{S}} ) & \end{matrix}$$

1.3 “Phase” of Signal Received from an Arbitrary ORT Located at a Delay “τ” from the Localization Unit

The expression below shows the argument or phase for a generic ORT signal as received by an exemplary User Terminal, after down-conversion and including “rules” to calculate its value at a specific sample time “kT_{S}” and a function of the sampling frequency f_{S0} including uncertainty Δf_{S} and fractional sampling time α=ΔT_{S}/T_{S}.

$$- 2 π ( p ( {f}_{{S}_{0}} + Δ {f}_{S} ) - qr ( {f}_{{S}_{0}} + Δ {f}_{S} ) ) ( \frac{α}{{f}_{{S}_{0}}} + \frac{k ( 1 - \frac{Δ {f}_{S}}{{f}_{{S}_{0}}} )}{{f}_{{S}_{0}}} ) + 2 m π ( {f}_{{S}_{0}} + Δ {f}_{S} ) ( - τ + \frac{α}{{f}_{{S}_{0}}} + \frac{k ( 1 - \frac{Δ {f}_{S}}{{f}_{{S}_{0}}} )}{{f}_{{S}_{0}}} ) \qquad Equation ( 9 )$$

### 2. Intra-Band Interferometric Signals

2.1 Argument (or Phase) of Baseband Signals after the First-Step Mixing

The expression below shows the resulting argument or phase of the resulting signal after down conversion using the chirped IF signal (i.e., r≠0) applied to the lower RF sub-band:

$$- 2 π ( p ( {f}_{{S}_{0}} + Δ {f}_{S} ) - qr ( {f}_{{S}_{0}} + Δ {f}_{S} ) ) ( \frac{α}{{f}_{{S}_{0}}} + \frac{k ( 1 - \frac{Δ {f}_{S}}{{f}_{{S}_{0}}} )}{{f}_{{S}_{0}}} ) + 2 m π ( {f}_{{S}_{0}} + Δ {f}_{S} ) ( - τ + \frac{α}{{f}_{{S}_{0}}} + \frac{k ( 1 - \frac{Δ {f}_{S}}{{f}_{{S}_{0}}} )}{{f}_{{S}_{0}}} ) \qquad Equation ( 10 )$$

The expression below shows the argument of phase of the resulting signal after down-conversion using the standard IF signal (i.e., r=0) applied to the upper RF sub-band:

$$- 2 p π ( {f}_{{S}_{0}} + Δ {f}_{S} ) ( \frac{α}{{f}_{{S}_{0}}} + \frac{k ( 1 - \frac{Δ {f}_{S}}{{f}_{{S}_{0}}} )}{{f}_{{S}_{0}}} ) + 2 n π ( {f}_{{S}_{0}} + Δ {f}_{S} ) ( - τ + \frac{α}{{f}_{{S}_{0}}} + \frac{k ( 1 - \frac{Δ {f}_{S}}{{f}_{{S}_{0}}} )}{{f}_{{S}_{0}}} ) \qquad Equation ( 11 )$$

The expression below shows the resulting argument or phase of the resulting interferometric signal

$$- 2 p π ( {f}_{{S}_{0}} + Δ {f}_{S} ) ( \frac{α}{{f}_{{S}_{0}}} + \frac{k ( 1 - \frac{Δ {f}_{S}}{{f}_{{S}_{0}}} )}{{f}_{{S}_{0}}} ) + 2 π ( p ( {f}_{{S}_{0}} + Δ {f}_{S} ) - qr ( {f}_{{S}_{0}} + Δ {f}_{S} ) ) ( \frac{α}{{f}_{{S}_{0}}} + \frac{k ( 1 - \frac{Δ {f}_{S}}{{f}_{{S}_{0}}} )}{{f}_{{S}_{0}}} ) - 2 m π ( {f}_{{S}_{0}} + Δ {f}_{S} ) ( - τ + \frac{α}{{f}_{{S}_{0}}} + \frac{k ( 1 - \frac{Δ {f}_{S}}{{f}_{{S}_{0}}} )}{{f}_{{S}_{0}}} ) + 2 n π ( {f}_{{S}_{0}} + Δ {f}_{S} ) ( - τ + \frac{α}{{f}_{{S}_{0}}} + \frac{k ( 1 - \frac{Δ {f}_{S}}{{f}_{{S}_{0}}} )}{{f}_{{S}_{0}}} ) \qquad Equation ( 12 )$$

Here is the above argument or phase of the complex baseband normalized for f_{S0}=1 and re-written in the form of a function of the sample “k,” fractional sample time offset “a,” sampling frequency offset “Δf_{S},” and total propagation delay “τ” from the ORT to the User Terminal.

−2pπ(α+k(1−Δf_{S}))(1+Δf_{S})−2mπ(α−τ+k(1−Δf_{S}))(1+Δf_{S})+2nπ(α−τ+k(1−Δf_{S}))(1+Δf_{S})+2π(α+k(1−Δf_{S}))(p(1+Δf_{S})−qr(1+Δf_{S})) Equation (13)

### 2.1 Interferometric Phase at Node #A Assumed as Reference

Here is the expression for the differential phase obtained at the other node (e.g., node #A), when α=0 and Δf_{S}=0 for a sample number=k_{A}. Please note that for this node, both Df_{S} and a are “zero” because node #A is assumed to be the reference.

$$- 2 p π {k}_{A} + \frac{2 π ( {pf}_{{S}_{0}} - {qrf}_{{S}_{0}} ) {k}_{A}}{{f}_{{S}_{0}}} - 2 m π {f}_{{S}_{0}} ( \frac{{k}_{A}}{{f}_{{S}_{0}}} - {τ}_{A} ) + 2 n π {f}_{{S}_{0}} ( \frac{{k}_{A}}{{f}_{{S}_{0}}} - {τ}_{A} ) \qquad Equation ( 14 )$$

### 2.3 Interferometric Phase at Node #B

For the non-reference node, α≠0 and Δf_{S}≠0 differential phase for the non reference, delay between the ORT and the two nodes, although arbitrary, can always be written as being composed of an integer number of samples plus a fractional sample time T/2≦α<T/2. Below, for convenience, we have re-written the differential phase at node #1 (at a delay τ_{A} from the ORT) at a specific sample k_{A}.

$$- 2 p π ( {f}_{{S}_{0}} + Δ {f}_{S} ) ( \frac{α}{{f}_{{S}_{0}}} + \frac{{k}_{B} ( 1 - \frac{Δ {f}_{S}}{{f}_{{S}_{0}}} )}{{f}_{{S}_{0}}} ) + 2 π ( p ( {f}_{{S}_{0}} + Δ {f}_{S} ) - qr ( {f}_{{S}_{0}} + Δ {f}_{S} ) ) ( \frac{α}{{f}_{{S}_{0}}} + \frac{{k}_{B} ( 1 - \frac{Δ {f}_{S}}{{f}_{{S}_{0}}} )}{{f}_{{S}_{0}}} ) - 2 m π ( {f}_{{S}_{0}} + Δ {f}_{S} ) ( \frac{α}{{f}_{{S}_{0}}} + \frac{{k}_{B} ( 1 - \frac{Δ {f}_{S}}{{f}_{{S}_{0}}} )}{{f}_{{S}_{0}}} - {τ}_{B} ) + 2 n π ( {f}_{{S}_{0}} + Δ {f}_{S} ) ( \frac{α}{{f}_{{S}_{0}}} + \frac{{k}_{B} ( 1 - \frac{Δ {f}_{S}}{{f}_{{S}_{0}}} )}{{f}_{{S}_{0}}} - {τ}_{B} ) \qquad Equation ( 15 )$$

### 3. Correlation Between Interferometric Signals of Two Participating Nodes

At node B, the differential phase with respect to node A is obtained by correlating the intra-band interferometric signal captured locally (i.e., at node B) with the corresponding interferometric signal received from the other node (i.e., node A). The expression below shows the argument or phase the result from the correlation of these two signals for a generic correlation sample “k.”

$$- \frac{1}{{f}_{{S}_{0}}^{2}} 2 π ( ( m - n + qr ) α {f}_{{S}_{0}} Δ {f}_{S} - ( m - n + qr ) {k}_{B} Δ {f}_{S}^{2} + ( m - n ) {f}_{{S}_{0}}^{3} ( {τ}_{A} - {τ}_{B} ) + {f}_{{S}_{0}}^{2} ( m α - n α + qr α - ( m - n + qr ) {k}_{A} + ( m - n + qr ) {k}_{B} - m Δ {f}_{S} {τ}_{B} + n Δ {f}_{S} {τ}_{B} ) ) \qquad Equation ( 16 )$$

### 4. Estimates for Delay, Frequency and Time Differentials

### 4.1 Differential Delay Estimate (Assuming Both Sampling Time and Sampling Frequency Synchronization

Let's assume, for simplicity, that the block of samples received from node #A has already been corrected for the estimates of both fractional sample time offset (a) and sampling frequency offset (Δf_{S}). The actual corrections are described later.

The phase for a generic correlation sample can then be written as:

$$- \frac{2 π ( \begin{matrix}{f}_{{S}_{0}}^{2} ( - ( m - n + qr ) {k}_{A} + ( m - n + qr ) {k}_{B} ) + \\ ( m - n ) {f}_{{S}_{0}}^{3} ( {τ}_{A} - {τ}_{B} )\end{matrix} )}{{f}_{{S}_{0}}^{2}} \qquad Equation ( 17 )$$

At the correlation peak (given by k_{B}=(k_{A}+Δk) with Δk=0), the above argument or phase provides a direct measurement of the differential delay “τ_{B}−τ_{A}” as illustrated below.

Here is the phase value at an offset Δk≠0 from the peak:

$$\\ - \frac{2 π ( \begin{matrix}{f}_{{S}_{0}}^{2} ( - ( m - n + qr ) {k}_{A} + \\ ( m - n + qr ) ( Δ k + {k}_{A} ) ) + \\ ( m - n ) {f}_{{S}_{0}}^{2} ( {τ}_{A} - {τ}_{B} )\end{matrix} )}{{f}_{{S}_{0}}^{2}} \qquad Equation ( 18 )$$

Here is the corresponding value when measured at the correlation peak (i.e., Δk=0)

−2(m−n)πf_{S}_{₀}(τ_{A}−τ_{B}) Equation (19)

Therefore, for a measurement made at the peak (i.e., high SNR), the differential delay estimate can be written as:

−τ_{A}+τ_{B} Equation (20)

### 4.2 Frequency Synchronization Estimate

The frequency offset is estimated directly (at each block and then averaged over multiple blocks) by comparing successive samples in the same block. For SNR reasons, this operation is performed at around the peak and as described below.

First the blocks are aligned. Below is the expression of the argument or phase for the “correlation sample phase for aligned blocks” at a generic sample k_{A}.

$$- \frac{1}{{f}_{{S}_{0}}^{2}} 2 π ( ( m - n + qr ) α {f}_{{s}_{0}} Δ {f}_{S} - ( m - n + qr ) {k}_{A} Δ {f}_{S}^{2} ( m - n ) {f}_{{S}_{0}}^{3} ( {τ}_{A} - {τ}_{B} ) + {f}_{{S}_{0}}^{2} ( m α - n α + qr α - m Δ {f}_{S} {τ}_{B} + n Δ {f}_{S} {τ}_{B} ) ) \qquad Equation ( 21 )$$

Next we read the phase value at the correlation peak (i.e., k_{A}=k_{PEAK})

$$- \frac{1}{{f}_{{S}_{0}}^{2}} 2 π ( ( m - n + qr ) α {f}_{{S}_{0}} Δ {f}_{S} - ( m - n + qr ) {k}_{PEAK} Δ {f}_{S}^{2} + ( m - n ) {f}_{{S}_{0}}^{3} ( {τ}_{A} - {τ}_{B} ) + {f}_{{S}_{0}}^{2} ( m α - n α + qr α - m Δ {f}_{S} {τ}_{B} + n Δ {f}_{S} {τ}_{B} ) ) \qquad Equation ( 22 )$$

Then we read the phase value at a point off peak, for instance by one sample (i.e., k_{A}=k_{PEAK}−1)

$$- \frac{1}{{f}_{{S}_{0}}^{2}} 2 π ( ( m - n + qr ) α {f}_{{S}_{0}} Δ {f}_{S} - ( m - n + qr ) ( - 1 + {k}_{PEAK} ) Δ {f}_{S}^{2} + ( m - n ) {f}_{{S}_{0}}^{3} ( {τ}_{A} - {τ}_{B} ) + {f}_{{S}_{0}}^{2} ( m α - n α + qr α - m Δ {f}_{S} {τ}_{B} + n Δ {f}_{S} {τ}_{B} ) ) \qquad Equation ( 23 )$$

Finally we compute the differential phase at around the peak

$$\frac{2 π ( m - n + qr ) Δ {f}_{S}^{2}}{{f}_{{S}_{0}}^{2}} \qquad Equation ( 24 )$$

As shown, the above differential phase provides a measure (i.e., an estimate) of the differential frequency (Δf_{S}/f_{S0}) squared.

The above steps could be simplified and the estimate for the differential frequency be obtained directly through a derivative operation using the correlation as per equation expression (21) as below:

$$\frac{2 π ( m - n + qr ) Δ {f}_{S}^{2}}{{f}_{{S}_{0}}^{2}} \qquad Equation ( 25 )$$

It is important to observe that the estimate above is for Δf_{S}².

Finally, using the nominal value for f_{S0}, the estimate for the frequency differential Δf_{S}² could be obtained.

### 4.3 Estimate for the Fractional Sample Time Offset (α)

The method uses the above estimate for the frequency differential Δf_{S} to calculate the fractional sample time offset α.

The argument or phase of the corrected signal after the correction for the frequency differential (i.e., Δf_{S}=0) can be expressed as

−2π(mα−nα+qrα+(m−n)(τ_{A}−τ_{B})) Equation (26)

Repeating the same operation for a neighbor (e.g., next block) in which the chirped mixing has been performed with a parameter r≠0 (e.g., r=1)

−2π(mα−nα+q(1+r)α+(m−n)(τ_{A}−τ_{B})) Equation (27)

The above two values can be used to find the differential phase at around the peak as below:

2πqα Equation (28)

As shown, the above correlation differential phase when performer in the vicinity of the correlation peak provides a high SNR estimate of the fractional sample time α.

What is claimed is:

1. A method for determining the position of a first User Terminal based on differential pseudo-ranges between at least two User Terminals including the first User Terminal and at least four non-aligned radio-frequency signal Transmitters comprising: receiving at the first User Terminal a radio frequency signal from a first Transmitter; selecting at least two spectrum segments including sub-channels with distinct center frequencies and arbitrary bandwidth; capturing a first signal block containing information of the pseudo-range between the first User Terminal and first Transmitter based on the phase differential between the center-frequencies; capturing a second signal block containing additional information related to frequency and sampling time synchronization between User Terminals; receiving corresponding signal blocks from a second User Terminal; correlating signal blocks from different User Terminals; determining the Alignment between blocks based on the position of the correlation peak; determining the differential pseudo-range between the first and second User Terminals and the first Transmitter based on the argument or phase of the correlated signal; determining the differential or fractional sampling time between User Terminals based on differential pseudo-ranges measured at different correlation times; determining the differential sampling frequency based on correlations between first and second blocks from different User Terminals; correcting the differential pseudo-range for the alignment between blocks, differential frequency and differential fractional sampling time; repeating prior measurements for at least three additional radio-frequency transmitters or User Terminals at known positions; determining the position of the first and second User Terminals relative to the position or coordinates of the transmitters based on the differential pseudo-range between the two User Terminals and the at least four non-aligned transmitters.

2. The method of claim 1 in which the radio-frequency transmitter is a broadcast TV, broadcast radio, cell base station or otherwise any other opportunistic transmitter including an User Terminal at a known position

3. The method of claim 1 in which the opportunistic transmitter can be a pseudolite including a drop-along noise like radio frequency source.

4. The methods of claims 1 and 2 in which the radio frequency signal from the opportunistic signal can be any analog or digitally modulated radio-frequency signal including signals with arbitrary spectrum and bandwidth.

5. The method of claim 1 in which the argument or phase measurements are made at or at around the correlation peak and have high SNR.

6. The method of claims 1 in which at least one spectrum segment or sub-channel can be from a collocated but different second transmitter including a transmitter of different type, different frequency band and different bandwidth including a first and second transmitters in the same tower.

7. The methods of claims 1 through 6 in which the signal from the opportunistic transmitter may not have any distinguishable feature including a synchronization signal or sub-channel including signals that are like noise.

8. The method of claim 1 in which the signals are collected by the User Terminals but the correlations, differential pseudo-range estimates and position of the User Terminals are performed somewhere else including at least one of the opportunistic transmitters.

9. The method of claim 1 in which at least one the opportunistic transmitters may be on a mobile platform including but not limited to UAVs, airplanes and satellites.

10. The methods of claims 1 through 9 in which the position of at least one opportunistic transmitter is determined based on the positions of at least four other User Terminals and transmitters at known positions.

11. The methods of claims 1 through 10 in which the User Terminals integrate with other geolocation systems including GPS and/or inertial navigation systems or INS.

12. The methods of claims 1 through 11 in which the User Terminals use GPS whenever available to determining the position of an opportunistic Transmitters and then use such a Transmitter to determine the positions of User Terminals when access to GPS is denied to at least one of the User Terminals.
